(19) United States
(12) Patent Application Publication
(10) Pub. No.: US 2002/0030662 A1
(43) Pub. Date: Mar. 14, 2002

(54) Display sign and controller

(76) Inventor: Richard George Mari, Vancouver (CA)

Correspondence Address: CLARK, WILSON, 800 - 885 WEST GEORGIA STREET, VANCOUVER, BC, V6C 3H1, CA

(21) Appl. No.: 09/906,652

(22) Filed: Jul. 18, 2001

Related U.S. Application Data
(63) Continuation of application No. 60/220,693, filed on Jul. 18, 2000.

(51) Int. Cl. G09G 5/00

(52) U.S. Cl. 345/156

(57) ABSTRACT

A controller for a display sign that displays a series of posters aligned in a row, including a top roller and a bottom roller, controlled by top and bottom motors, respectively. The sign displays one a series of posters arranged on a roll. The posters not in display remain wrapped around the top and bottom rollers as appropriate. The controller allows the poster's positions to be set relative to the rotation of the motors or rollers. When the motor operates to move the rollers to position another poster, the motor can decelerate gradually when approaching the other poster's position. The controller can also be used to program the order of display of the posters and the duration of time each poster is displayed.

### NOTICE REGARDING COPYRIGHTED MATERIAL

A portion of the disclosure of this patent document contains material which is subject to copyright protection. The copyright owner has no objection to the facsimile reproduction by anyone of the patent document or the patent disclosure as it appears in the public Patent Office file or records but otherwise reserves all copyright rights whatsoever.

### TECHNICAL FIELD

This invention relates generally to display signs for outdoor advertising and particularly to such signs capable of displaying scrolling posters.

### BACKGROUND

Outdoor scrolling display signs are commonly found in locations where people congregate such as malls. Such signs are typically equipped with motors to move a single continuous sheet so that the individual posters (containing the advertisements) placed on the sheet can be displayed sequentially. The posters are moved from a lower roll to an upper roll in one direction. Once the lower roll is emptied, the direction of movement is reversed.

There are many difficulties with currently available scrolling display signs. For example, the individual posters tend to break and tear after a short period of use due to the strain placed on the posters by the varying weights of the roll (depending on how “full” the top portion of the roll is in relation to the lower portion) and the “stop and jerk” motion created by the motor. The advertisements tend to break and tear at their edges, and once this occurs, the entire advertisement must be replaced.

Furthermore, the control process for scrolling display signs is inefficient. Currently, the trigger to stop the motor is a marker (typically foil) sensed by the controller. This causes the scrolling motion to be halted suddenly when the marker is detected, adding stress to both the motor and the posters. This stress means that the number of posters that can be placed on a roll is limited to about six. Another difficulty is that to adjust these stopping points, the markers have to be physically moved on the posters, requiring a good deal of time and effort.

A further difficulty is that it is very difficult to change the order of display or length of time a poster is displayed without changing the posters or the controller. Therefore, making such changes is a time consuming and difficult process.

### SUMMARY OF THE INVENTION

The invention is a display sign and controller that overcomes the above-mentioned disadvantages of the prior art. For example, the controller records in memory (by pre-programming) the positions at which the motor should be stopped, allowing for a slower acceleration and deceleration of the roll and therefore, less stress on the motor and posters. Furthermore, a Mylar strip is placed on the edges of the posters, greatly prolonging their life, as the edges of the posters are the locations where they begin to tear and fray first. The strip can be easily replaced when necessary, rather than the more expensive poster.

The controller also offers a large number of advantages in controlling the time and order of the advertisements being displayed. For example, the controller can be manipulated by software to skip certain signs (even at only certain times) and/or to spend different amounts of time displaying different posters. This allows the sign operator great flexibility in managing the signs and allowing advertisers to appropriately target their products or services.

### BRIEF DESCRIPTION OF FIGURES

Further objects, features and advantages of the present invention will become more readily apparent to those skilled in the art from the following description of the invention when taken in conjunction with the accompanying drawings, in which:

FIG. 1 is a view of an embodiment of a controller showing the receptacles for the interface with a display sign according to the invention;

FIG. 2 is a is a view of an embodiment of the controller showing some controls built into the controller;

FIG. 3 is a schematic diagram of the controller assembly;

FIGS. 4 through 9 are flowcharts of the use of the programming process for the controller; and

FIG. 10 is a processing flow chart of the controller.

### DETAILED DESCRIPTION OF PREFERRED EMBODIMENTS

An advertising display sign for use with the invention preferably includes a top roller and a bottom roller, controlled by a top motor and a bottom motor, respectively. The sign is designed to display one of a series of posters arranged on a roll. When displaying posters, the sign will display a single poster on the roll, while the posters not on display remain wrapped around the top and bottom rollers as appropriate.

In a preferred embodiment of the display sign according to the invention, a user-programmable controller controls the speed and the direction of movement of the top and the bottom motors. In a preferred embodiment, the controller is programmed using software installed on a personal computer than can be connected to the controller through its serial port. However, it is also possible to program all or most of the functions (parameters) of the controller using switches that are located on the controller.

The user programs the controller so it contains in its memory the correct position of each poster in the display screen, the duration of display of each poster, and the rotation order for the display of the posters. Every time that new posters are to be installed in the display, an automatic “homing” sequence establishes a point of reference with respect to which the position of each poster will be calculated. The user adjusts the position of each poster in the display sign for optimal viewing. Once the optimal position for a poster is established, an encoder calculates the position of that particular poster in relation to the said point of reference and sends the result to the controller which saves it in its memory. The user also enters into the controller's memory the exposure time for each poster, and the rotation order for the posters, both in forward (top roll to bottom roll) and reverse (bottom roll top roll) rotations.

When the display sign is in operation, the controller will monitor, through its connection to the encoder, what is being displayed in the viewable area of the sign. Once a poster that is to be next displayed according to the order set by the user gets close to the viewable area of the display sign, the controller gradually slows down the speed of the top and bottom motors and brings them to a complete stop when the optimal position saved in the memory of the controller is reached. The controller will keep the motors in a stop position for the duration that the particular poster is to be displayed, as saved in the controller's memory, and will cause the motors to be reactivated upon expiry of the display duration for the poster. The controller will cause the motors to scroll through the posters and until the next poster to be displayed approaches the viewable area of the display, and then the process is then repeated.

Once the last poster to be displayed has been displayed for the designated duration, the controller will cause the direction of movement of the motors to be reversed, so for example, if the posters were moving from top roll to the bottom roll, after the change of direction, they will move from the bottom roll to the top roll. The controller repeat the same process as in the forward rotation for the reverse rotation, except that the rotation order for the posters will be the reverse rotation order set by the user.

In addition to the correct position and duration of display of each poster, and the forward and reverse rotation orders, the user can program the controller so it contains in its memory the hours of operation (on/off time) for the display sign, which could be for cycles of any number of days. The controller may also be programmed to contain more than one such cycles, so it is possible to have different operation times for the different cycles.

Furthermore, the controller may contain in its memory more than one rotation order for the posters (with each rotation order consisting of a forward and a reverse rotation order) so different selection of the posters are displayed during different hours that the display sign is operating. This will allow the user to target the particular audience that may view the display sign during different times of the day.

The controller also retains in its memory the user-selected values for the poster speed and for the bottom motor speed. Poster speed is the speed at which the display will change from one poster to another. The user may wish to use a slower speed in a more relaxed setting and a faster speed at a more fast pace location. The bottom motor speed, which in the absence of a selection by the user will be predetermined based on the poster speed, may also be selected by the user to adjust the tension in the poster roll. The increased tension will help reducing slack in a heavier poster roll caused by a larger than usual number of, or heavier-paper posters in the signs. A display sign according to the invention is capable of handling a larger roll of posters than is common in the art, because of the reduction of strain on the posters.

In the preferred embodiment of the invention, the user can program the controller using a personal computer that can be connected to the controller through their respective serial ports using an RS232 cable, and a Windows-based computer software, as described in Appendix C. The user installs the software on his or her personal computer, connects his or her personal computer to the controller with an RS232 cable and starts the software. Once the software is started, the “Poster Position” screen will appear on the screen (see Appendix C). Pressing the “Up” button, located at the lower half of the screen, the user should roll all the posters to the top roll. By pressing the “Disconnect” button, located at the bottom left part of the screen, the user will disconnect the link between the computer and the controller and at the same time initiates the homing sequence. In the homing sequence, the controller cause the motors to move the poster rolls until a photo limit switch senses a pre-designated spot on the poster roll and sends a signal to the controller to cause the motors to stop. The user will then re-establish the connection between the computer and the controller by clicking the any of “Connect”, “Up” or “Down” buttons. The user will then highlight “Poster 1” row on the “Poster-Position/Exp Time” chart on the left side of the screen. Using the “Up” and “Down” buttons, the user will move the first poster on the roll to the viewable part of the display, fine tuning the position of the poster for optimal viewing using the “Up” and “Down” buttons. Once the first poster is in optimal viewing position, the user clicks the “Set Position” button on the “Adjusting Poster” area of the screen. This will cause an encoder mounted on the bottom motor to calculated the correct position of the poster in relation to the homing position based on the rotation of the motor and transmit the location to the controller to be saved in the memory of the controller. The location of the first poster will then automatically appear in the “Position” column next to “Poster 1”, in the “Poster-Position/Exp Time” chart. Then the user will set the “Exposure Time”, also located in the “Adjusting Poster” area of the screen, to the desired duration of exposure by entering the appropriate number of hours, minutes and seconds, and then press the “Set Exposure” button which well save the desired duration of exposure time for the poster being displayed in the memory of the controller, and cause the selected exposure time to appear in the “Poster 1” row in the “Poster-Position/Exp Time” chart. Optionally the position of each poster is based on the rotation of the top and/or bottom rollers relative to the set position of the previous and/or following poster.

Then the user will select the total number of posters that are in the display sign from the “Number of Posters” menu located on the top right side of the screen. This will create an equal number of rows in the “Poster-Position/Exp Time” chart, with each row corresponding to a poster.

Then the user will proceed through the posters in the poster roll sequentially and repeat the process as in the first poster for each poster.

When the user has finished setting the position and exposure time for each poster, the user will go to the “Rotation Order” screen by clicking the corresponding button at the to left side of the screen. In the “Rotation Order” screen (see Appendix C), the numbers under each of the “Primary Rotation Order” and “Secondary Rotation Order” correspond to the position of each poster in the rotation as previously selected. The user will first select the posters that the user wants to be displayed during the “Primary Rotation Order”, in both in the forward and reverse rotations. The forward rotation start from top and goes to the bottom and the reverse rotation starts from the bottom of the list and goes to the top. Then the user will do the same thing for the “Secondary Rotation Order”. Finally the user will select the daily “Start” and “Stop” times for the secondary rotation from the corresponding menus, located on the right side of the screen. To enable the secondary rotation the user has to click the “Enable” box, also located on the right side of the screen. Otherwise the secondary rotation will be disables and the primary rotation will be used for the duration of operation of the display sign.

In another embodiment of the invention, the user has the option of setting the rotation order of the posters in a random order which does not follow the positions of the posters on the roll in the ascending or descending order. This means that the rotation order may poster 1, poster 3, poster 6, poster 2, poster 7, poster 5 and so on.

Next, the user will proceed to the “On/off Times” screen by clicking the corresponding button, located at the top of the screen. On the “On/Off Times” screen (see Appendix C), the user will select the operation time for each day of the week. This is done by selecting the on and off times for each day of the week under “Schedule 1” table, located on the left side of the screen. The user also has the option of entering a second weekly schedule under the “Schedule 2” table located on the right side of the screen. The user then selects the active schedule form the boxes under the “Active Schedule” menus, located at the bottom left side of the screen. The user will also set the controllers' internal timer from this screen, by selecting the correct local time and day of the week from the “Controller Clock” menu located at the bottom of the screen.

In another embodiment of the invention, the user has the option of creating more than two schedules, and can select the date on which each schedule becomes effective.

Next, the user will proceed to the “Advanced Features” screen by clicking the corresponding button, located at the top of the screen. On the “Advanced Features” screen, the user will select the speed for poster to poster changing from the “Poster Speed” menu. Setting of the poster speed automatically adjust speeds of the top and the bottom motors. However, to increase the tension in the poster roll and remove any slack, the user can override the predetermined value for the peed of the bottom motor by choosing a new value from the “Bottom motor Speed” Menu.

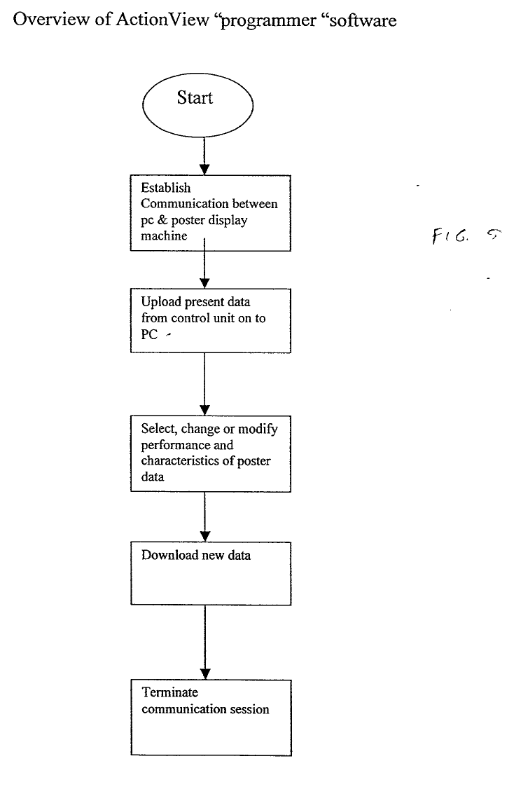

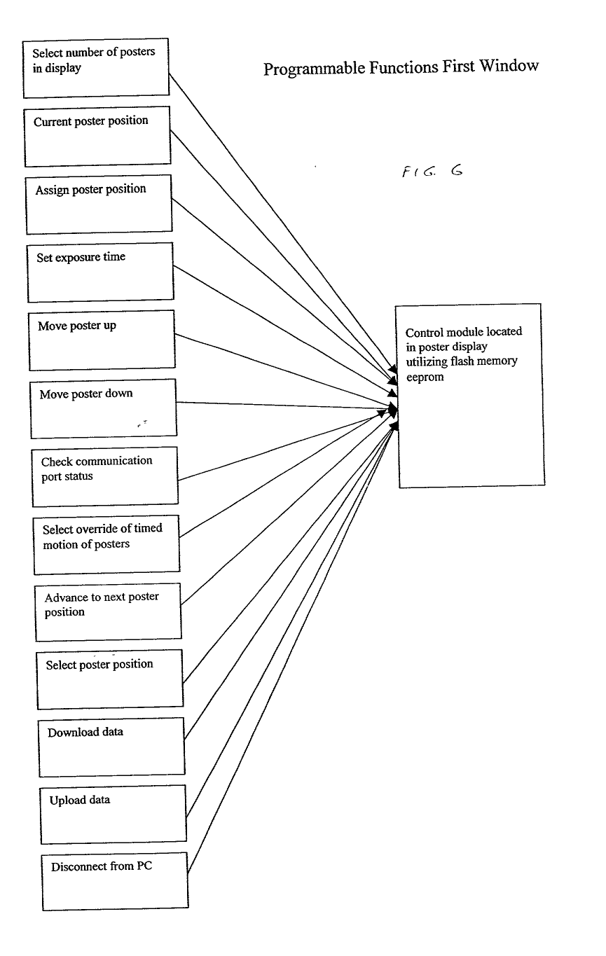

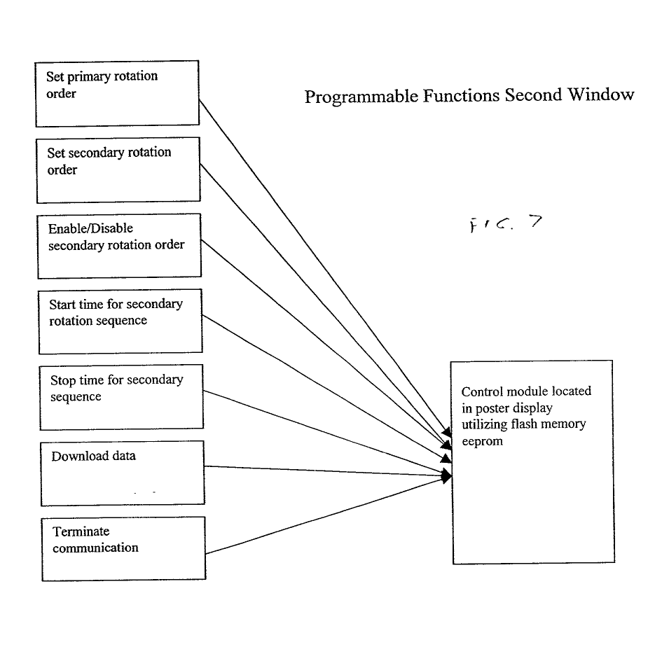

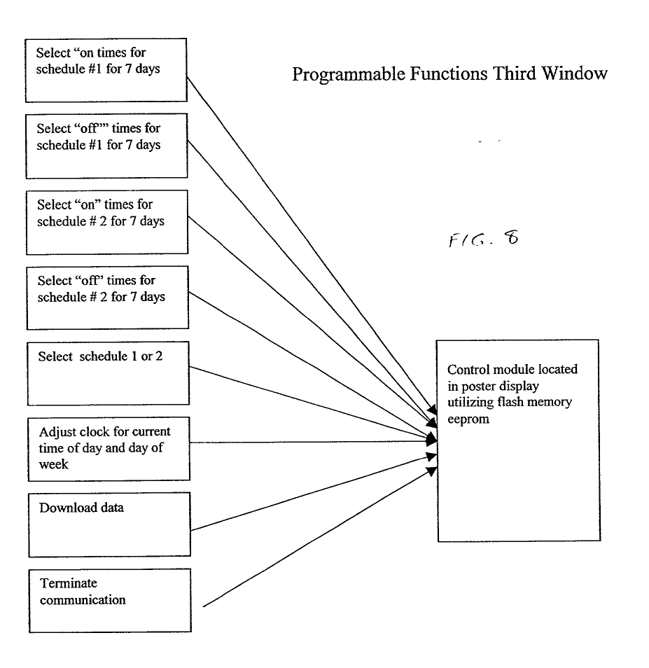

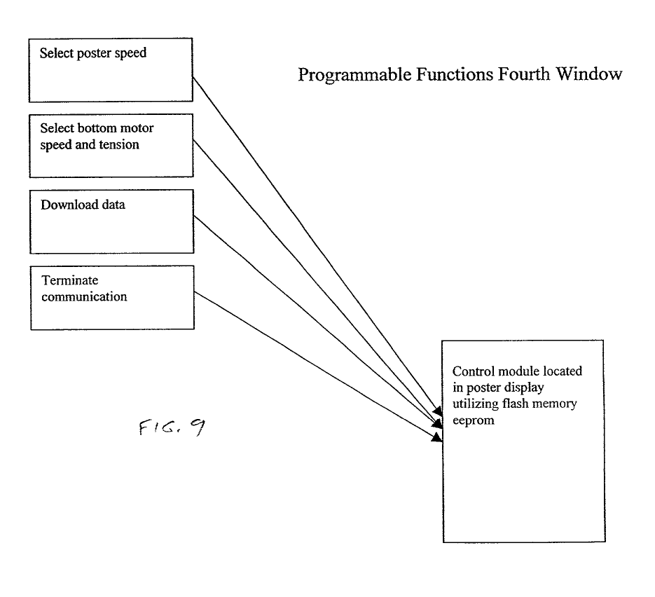

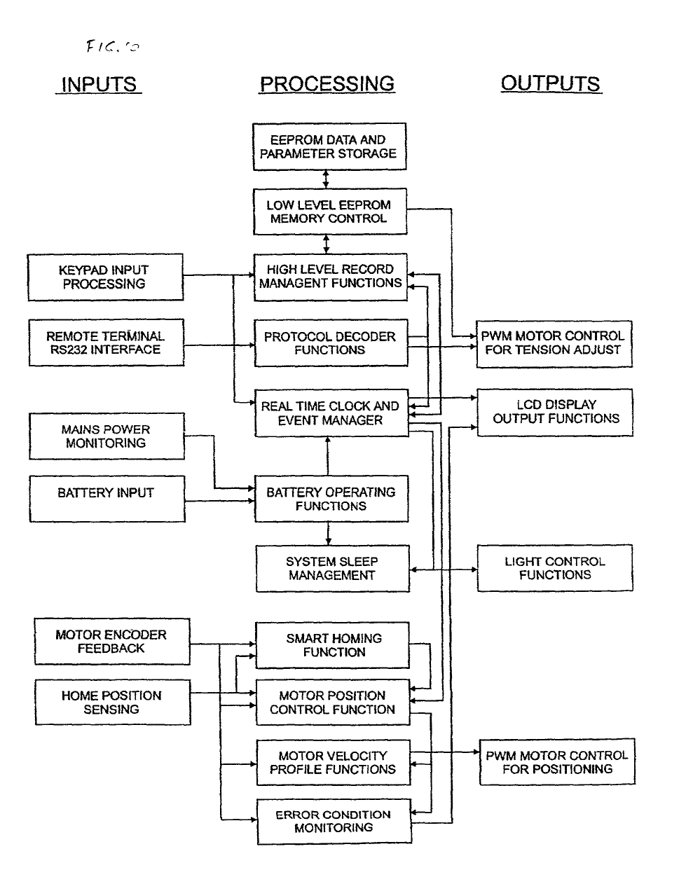

Flow charts for the entire programming process of the Controller appears in FIGS. 4 through 9.

Instead of going through the entire process of programming the controller as described above, the user can also just change only one or more parameters. For example, after starting the software and connecting his or her personal computer to the controller, the user can go the “On/Off Times” screen and change the on/off time for a single day of the week in Schedule 1, or change the active schedule.

During or at the end of any programming session, the user can check the effective positioning and order of the posters by going to the “Poster Position” screen (in Appendix C) and clicking the “Check Mode”, located near the bottom of the screen. Enabling the “Check Mode” feature, will cause a “Next Poster” button to appear on the screen (not shown). The user can then click the “Next Poster” button to advance to the next poster according to the rotation order. Through this process, the user can check that the correct rotation order is in place and that each poster in positioned correctly, and make the necessary adjustments as necessary.

Every time that the user completes a programming session, the user will click the “Download” button, located at the bottom right corner of each of the screens, to transmit all the selected values to the controller. Then the user will press the “Disconnect” button, also located at the bottom left comer of each screen, to disconnect the connection between his or her personal computer and the controller. Once the controller is disconnected, it will initiate the homing sequence, and will then start the display sign if the time is during the operation hours of the display sign, and will otherwise start the display sign the start of the on time, the following day.

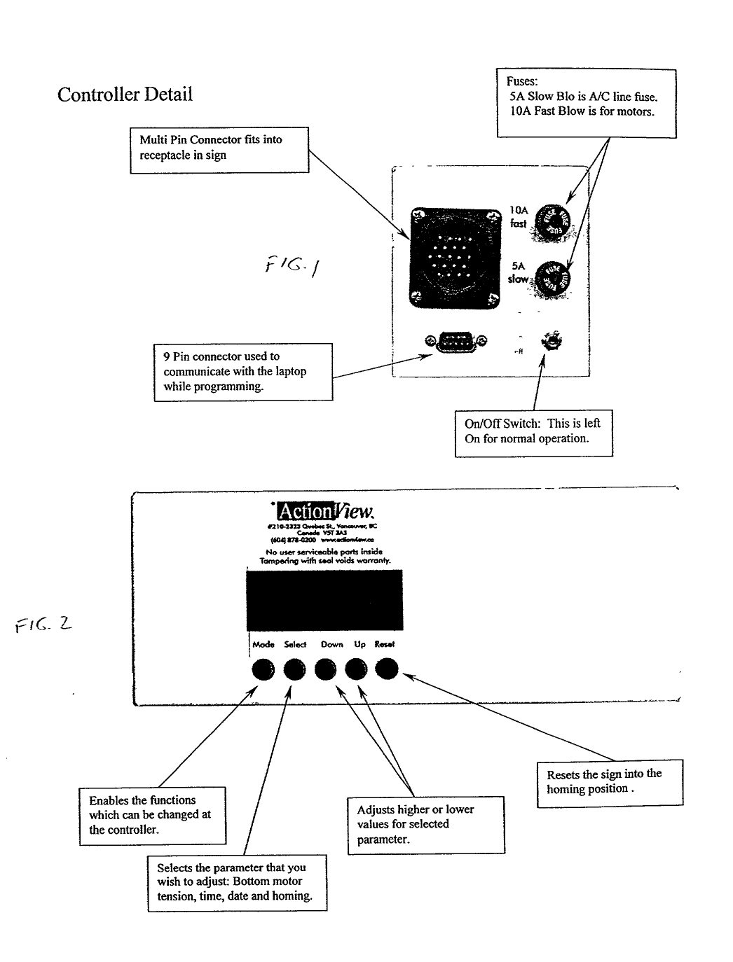

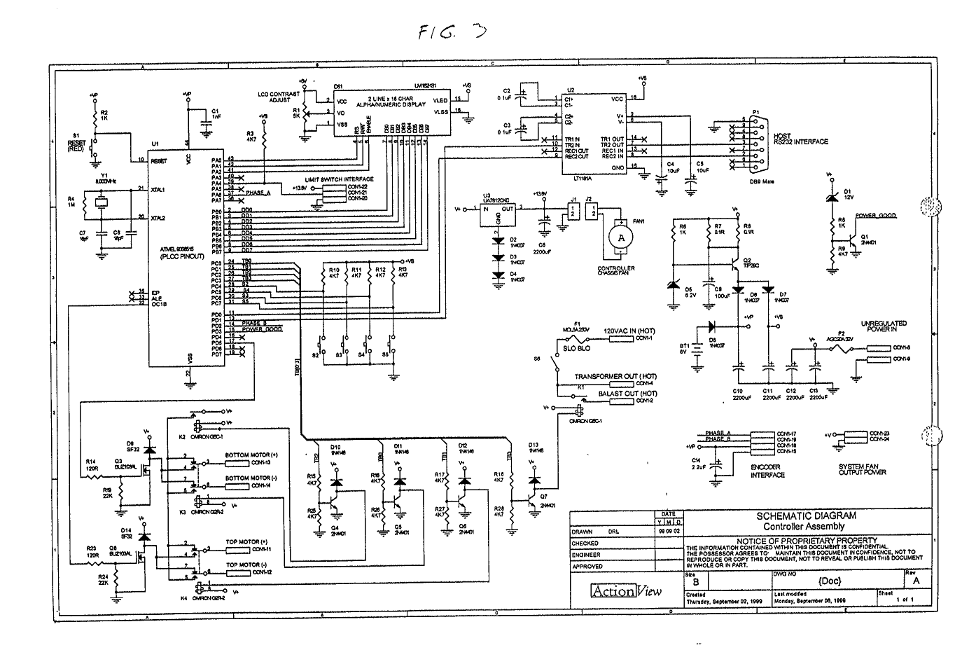

In the preferred embodiment, certain of the more often utilized functions (parameters) of the controller can be programmed directly into the controller (without using a personal computer) by using switches and a display located on the controller, as seen in FIGS. 1 and 2. In the preferred embodiment, the lower motor speed, which is adjusted to remove any slack form the posters roll, and the internal timer of the controller can be adjusted directly from the controller. In addition, the user can initiate the homing sequence directly form the controller.

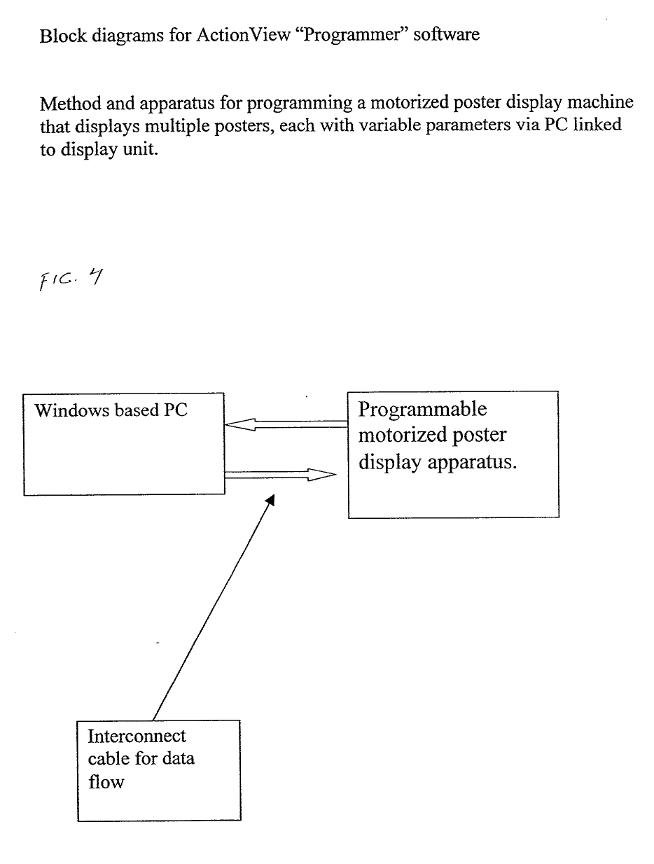

FIG. 3 shows the circuit diagram for an embodiment of the controller, including the connections between the controller and peripheral or external elements, including the top motor, the bottom motor, the encoder, the photo limit switch, the display sign fan, the RS232 serial receptacle located on the controller, the switches located on the controller, the display sign located on the controller, and the ballast controlling the fluorescent lights in the display sign. Appendix A shows the schematics of the electrical connections in an embodiment of the display sign.

A further feature of the invention is that polyester film, for example the film sold under the trade mark MYLAR, is used to coat the edges of each poster. This prevents the fraying of the edge of the poster, which is a common cause of degradation in the prior art, and thereby extends the life of the posters.

Further information about a preferred embodiment can be found in the following appendices:

Appendix A is a working drawing portfolio showing an embodiment of a physical layout of a preferred embodiment of the invention.

Appendix B is a manual containing pictures of an actual unit incorporating the preferred embodiment and describes the installation process for the posters.

Appendix C is a software manual of a preferred embodiment of the invention.

Appendix D is a technical description of a preferred embodiment of the invention.

Appendix E is a table showing the benefits of the invention.

While the principles of the invention have now been made clear in the illustrated embodiments, it will be immediately obvious to those skilled in the art that many modifications may be made of structure, arrangements, and algorithms used in the practice of the invention, and otherwise, which are particularly adapted for specific environments and operational requirements, without departing from those principles. The claims are therefore intended to cover and embrace such modifications within the limits only of the true spirit and scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A controller for a display sign having a plurality of posters arranged sequentially on a first roller and a second roller, and a motor for moving said first roller, comprising:
(a) means to store a position for each of said posters in said roll in said controller; and
(b) means to store a duration of display for each of said posters.

2. The controller of claim 1 wherein said controller actuates said motor to move said first roller after the duration of display for a first poster has expired to the position of a second poster according to the stored position of said second poster in said controller.

3. The controller of claim 2 wherein said motor gradually decelerates said first roller when said second poster approaches said stored position of said second poster.

4. The controller of claim 1 wherein said display sign further comprises a second motor for moving said second roller and said second motor moves said second roller after the duration of display for a first poster has expired to the position of a second poster according to the stored position of said second poster in said controller.

5. The controller of claim 2 wherein said controller further comprises means to adjust said duration of display for each of said posters.

6. The controller of claim 5 further comprising means to adjust the order of display of each of said posters.

7. The controller of claim 6 wherein a plurality of durations of display and order of display for each of said posters is stored in said controller.

8. The controller of claim 7 wherein said controller further comprises a clock, said controller using durations of display and an order of display for said posters based on the time on said clock.

9. The controller of claim 8 wherein said positions of each of said posters are based on the revolution of said first roller in relation to the position of said adjacent posters.

10. A method of controlling a display sign having a plurality of posters arranged sequentially on a first roller and a second roller, and a motor for moving said first roller, with a controller comprising the steps of:
(a) storing the position of each of said posters in said controller
(b) providing said controller with a duration of display for each of said posters;
(c) said controller actuating said motor to move said roller after the duration of display for a poster has expired to the position of another poster according to the stored position of said second poster in said controller.

11. The method of claim 10 wherein said position of each of said posters is based on the number of revolutions of said first and second rollers relative to said adjacent posters.

12. The method of claim 11 further comprising:
(d) providing said controller with an order of display for said posters.

13. The method of claim 12 wherein said controller gradually decelerates said motor when approaching the position of a poster.

13. A poster for use in a display sign having a plurality of posters arranged on a roll positioned on a first roller and a second roller, and motor for moving said first roller, comprising:
(a) a flat surface having a side with an image for display;
(b) first and second opposed sides, at least one of said first and second opposed sides connected to a second poster; and
(c) third and fourth opposed sides; and
(d) a polyester film covering the edges of said first and second sides.
